(19) United States
(12) Patent Application Publication
(10) Pub. No.: US 2002/0154356 A1
(43) Pub. Date: Oct. 24, 2002

(54) Optical transmission system with an improved signal-to-noise ratio

(76) Inventor: Peter Krummrich, Muenchen (DE)

Correspondence Address: Bell, Boyd & Lloyd LLC, P.O. Box 1135, Chicago, IL, 60690, US

(21) Appl. No.: 10/099,415

(22) Filed: Mar. 15, 2002

(30) Foreign Application Priority Data
Mar. 16, 2001 (DE) 101 12 805.3

(51) Int. Cl. H04B 10/08; H04J 14/02

(52) U.S. Cl. 359/124; 359/110

(57) ABSTRACT

In an optical transmission system, optical wavelength division multiplexed signals are transmitted via an optical fiber, wherein the signal-to-noise ratio of the optical transmission system is improved by setting the power levels of the optical WDM signals at the start of the optical fiber such that the optical WDM signals in the optical fiber have at least approximately the same minimum power levels, thus leading to the signal-to-noise ratios of the output of the optical transmission path being approximately the same.

### BACKGROUND OF THE INVENTION

The present invention relates to an optical transmission system with an improved signal-to-noise ratio for optical wavelength division multiplexed (WDM) signals using an optical fiber.

In existing optical transmission systems, particularly optical transmission systems which operate using the WDM principle (wavelength division multiplexing), optical pump signals from a pump signal source are coupled, for example, codirectionally or in opposite directions into an optical monomode fiber in order to supply the necessary optical pump power to the input location for upstream or downstream optical amplifiers. Such optical pump signals are used in a corresponding manner for direct amplification of optical signals to be transmitted, particularly optical WDM signals, with the optical amplification produced by the optical pump signals being based on the Raman effect. The Raman effect, or stimulated Raman scatter, is described, for example, on pages 329-334 of Godwin P. Agrawal: “Non-linear Fiber Optics”, Second Edition, 1995.

Furthermore, concepts for distributed Raman amplification in optical transmission fibers are known which allow a considerable improvement in the transmission characteristics of the optical transmission system by distributing the amplification points over a portion of, or over the entire, optical transmission path. By way of example, use of the distributed Raman amplification technique at the end of the optical transmission path allows an improved optical signal-to-noise ratio (OSNR), which is constant over all the optical WDM signals, to be achieved, as a result of which it is possible to considerably increase the optical transmission path length which can be bridged without regeneration, and a number of optical transmission path sections can be bridged without any additional regeneration.

However, the noise factor spectrum of the Raman amplifier and the minimum power levels of the optical WDM signals along the optical transmission path are critical for improving the system characteristics, particularly with regard to the signal-to-noise ratio, of an optical transmission system. For uniform amplification of each optical WDM signal via, for example, a distributed Raman amplifier, it is advantageous for the noise factors and the minimum power levels of all the optical WDM signals to match in the optical Raman amplifier. If this is not the case, the system improvements are restricted by that optical WDM signal having the lowest minimum power level and/or having the poorest noise ratio. The pump signal power which is used within the Raman amplification thus is not used efficiently and cannot be used to increase the distances between the intermediate amplifiers or to increase the number of optical fiber path sections which can be bridged.

In a distributed Raman amplifier with a large number of pump wavelengths and an approximately flat gain spectrum, different minimum power levels generally occur in the optical transmission fiber. These different levels are due primarily to a broad gain spectrum resulting from interactions between the pump radiation components at the individual pump wavelengths due to stimulated Raman scatter. Other reasons may include different fiber attenuations at the WDM signal wavelengths or power level differences due to stimulated Raman scatter at the start of the optical transmission path. The noise factors of the amplifier for the individual optical WDM signals also differ from one another in a similar manner. The different minimum power levels and/or noise factors of the optical WDM signals result in different signal-to-noise ratios at the output of the optical transmission fiber section. Thus, although it is possible to set identical power levels for the optical WDM signals at the output of the optical transmission fiber, it is possible for different signal-to-noise ratios to occur at the output of the optical transmission fiber section for the optical WDM signals.

Distributed Raman amplifiers which have been used until now for optical WDM transmission systems provide a number of pump sources, particularly laser diodes, whose pump signals are each at a different wavelength. The form of the gain spectrum produced by the optical pump signals, or the gain per optical WDM signal, can be influenced by the choice of the pump power levels at the individual wavelengths. In this case, the power levels of the optical pump signals are chosen so as to produce a gain spectrum that is as flat as possible or approximately uniform amplification for all the optical WDM signals; that is to say, the Raman amplifier is operated in its linear operating mode.

A further approach for improving the signal-to-noise ratio of the optical transmission system is to provide a Raman amplifier in which the pump power of the optical pump sources is distributed such that the optical WDM signals have approximately the same minimum power levels within the optical transmission fiber after amplification. However, in this operating mode, the power levels of the optical WDM signals differ considerably from one another due to the interactions between the optical pump signals. This leads to a deterioration in the signal quality of the optical WDM signals as the amplification is increased, due to the Rayleigh backscatter being doubled.

Furthermore, in order to optimize the optical signal-to-noise ratio of optical transmission paths and, hence, to optimize the system characteristics of optical WDM transmission systems, the WDM signals are subjected to preemphasis, with regard to their signal power level, of the input to the optical WDM transmission path, that is to say in the transmitting unit, as a function of the characteristics of the optical WDM transmission path, via attenuation elements. As such, the optical signal-to-noise ratios (OSNR) of the optical WDM signals have virtually the same value at the end of the optical WDM transmission path; that is, in the optical receiving unit. Such preemphasis of the signal levels of the optical WDM signals to be transmitted compensates for the respective transmitter scatter, which is different for each optical WDM signal, and for the different transmission characteristics of the optical transmission system for different wavelengths. To this end, methods are known for controlling the signal-to-noise ratio of optical WDM signals by determining the signal-to-noise ratios at the end of the transmission path, in which methods the determined signal-to-noise ratios are used to obtain a control signal for controlling the preemphasis at the input of the optical transmission path. In this context, see, in particular, European Patent Application 92310342.8. Thus, in methods such as these, the signal-to-noise ratio at the end of the optical WDM transmission path is in each case controlled by controlled attenuation of the signal power levels of the optical WDM signals and by continuously variable control of the optical transmitting units for producing the optical WDM signals at the input of the optical WDM transmission path.

An object to which the present invention is directed, therefore, is to improve the signal-to-noise ratio of an optical transmission system.

### SUMMARY OF THE INVENTION

Accordingly, a major aspect of the optical transmission system according to the present invention with an improved signal-to-noise ratio is that the power levels of the optical WDM signals at the start of the optical fiber are set such that the optical WDM signals in the optical fiber have at least approximately the same minimum power levels. The adjustment or matching of the power levels of the optical WDM signals, according to the present invention, at the input of the optical fiber advantageously results in the minimum power levels of the optical WDM signals in the optical fiber being matched to one another, hence improving the signal-to-noise ratios of the transmitted optical WDM signals. In consequence, the optical WDM signals at the end of the optical transmission path have approximately the same signal-to-noise ratios, so that the transmission range which can be bridged without regeneration is increased, while at the same time allowing improved reconstruction of the optical WDM signals.

A measurement unit advantageously is provided for determination of the minimum power levels of the optical WDM signals in the optical fiber. A measurement unit, such as an OTDR test set, is used to determine the distribution of the power of the optical WDM signals along the optical transmission path, with the adjustment or matching of the power levels of the optical WDM signals according to the present invention being carried out as a function of this, at the input of the optical transmission path.

A further advantage of the present invention is that a control unit is provided for evaluation of the measured minimum power levels and, based on this, for formation of actuating signals, via which the input power levels of the optical WDM signals are set at the start of the optical fiber. Furthermore, the control unit is provided for determination of the greatest minimum power level of the optical WDM signals and for determination of the difference levels between the greatest minimum power level and the further minimum power levels, with the input power levels of the optical WDM signals being matched, with the aid of the actuating signals, at the start of the optical fiber in order to reduce the determined difference levels. As a result of the evaluation, according to the present invention, of the minimum power levels determined with the aid of the measurement unit and the matching of the power levels of the WDM signals at the start of the optical transmission path by the determined difference level, all the optical WDM signals have approximately the same minimum power levels and, hence, a similar noise ratio along the optical transmission path.

A particularly advantageous feature in one embodiment of the optical transmission system according to the present invention is the provision of at least one Raman amplifier with a number of optical pump signal sources for amplification of the optical WDM signals, whose pump signal power levels are chosen such that the signal levels of the optical WDM signals are amplified at least approximately to the same extent. Although the linear operation of the Raman amplifier advantageously raises the power of the respective optical WDM signal, the power distribution, according to the present invention, of the optical WDM signals within the optical transmission system is not changed, however.

Additional features and advantages of the present invention are described in, and will be apparent from, the following Detailed Description of the Invention and the Figures.

### BRIEF DESCRIPTION OF THE FIGURES

FIG. 1 shows, by way of example, the basic design of an optical transmission system according to the present invention with an improved signal-to-noise ratio.

FIG. 2 shows the profiles of the power levels of the individual optical WDM signals along the optical transmission path, when the input power levels are approximately the same.

FIG. 3 shows the profiles of the power levels of the individual optical WDM signals along the optical transmission path, when the input power levels have been adjusted according to the present invention.

FIG. 4 shows, by way of example, a comparison of the signal-to-noise ratios of the optical WDM signals plotted against the wavelength of the output of the optical transmission system, when the input power levels are approximately the same and after adjustment of the input power levels according to the present invention.

FIG. 5 shows the profile of the amplification of a Raman amplifier, operated in the linear mode, plotted against the wavelength.

### DETAILED DESCRIPTION OF THE INVENTION

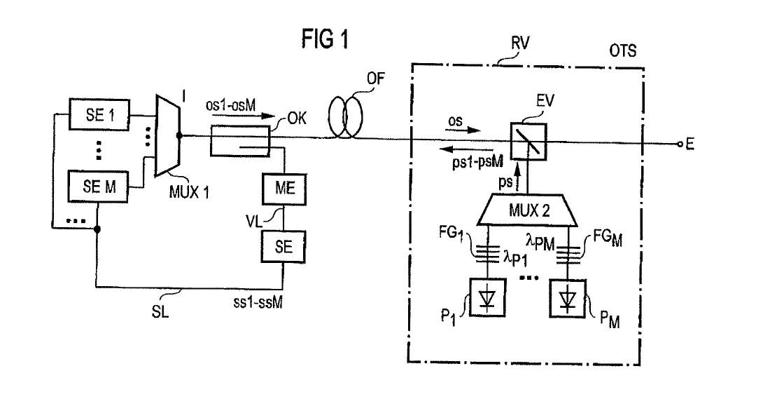

By way of example, FIG. 1 shows an optical transmission system OTS which has an optical transmission fiber OF, a first multiplexer MUX1, a measurement unit ME, a control unit SE, first to M-th adjustable transmitting units SE1 to SEM, and a Raman amplifier RV. The Raman amplifier RV includes an optical coupling unit EF, a second multiplexer MUX2, first to M-th filter units FG₁ to FG_{M}, as well as first to M-th pump sources P₁ to P_{M}. In the illustrated exemplary embodiment, the optical transmission system OTS includes an optical transmission path section which has an input I and an output E and has a length of about 100 km, and an attenuation coefficient of 0.21 dB/km. However, the present invention is in no way restricted to one optical transmission path section, but also can be applied to a number of series-connected optical transmission path sections.

At the input I of the optical transmission system OTS or of the optical transmission path, the outputs of the first to M-th adjustable transmitting units SE1 to SEM are connected to the first multiplexer MUX1, to whose output the optical transmission fiber OF is connected. Several kilometers upstream of the output E of the optical transmission system OTS, an optical coupling device EF is connected into the optical transmission fiber OF in order to couple the optical pump signals ps1 to psM in the opposite direction into the optical fiber OF, which is connected to the output of the second multiplexer MUX2. One input of the second multiplexer MUX2 is, in each case, connected to one of the first to M-th pump sources P₁ to P_{M}, via a respective first to M-th filter unit FG₁ to FG_{M}. By way of example, FIG. 1 shows the first and M-th pump sources P₁, P_{M} as well as the first and M-th filter units FG₁, FG_{M}.

Furthermore, the measurement unit ME is connected via an optical coupling unit OK to the optical fiber OF, and is connected to the control unit SE via a connecting line VL. The control unit SE is connected via actuating lines SL to a respective one of the adjustable transmitting units SE1 to SEM.

In the first to M-th adjustable transmitting units SE1 to SEM, optical WDM signals os1 to osM are produced at different wavelengths λ1 to λM, which are combined by the first optical multiplexer MUX1 to form a common optical transmission signal os, and are transmitted via the optical transmission fiber OF to the output E of the optical transmission system OTS. In this case, the individual optical WDM signals os1 to osM and the overall optical transmission signal os are subject to specific amplification via the Raman amplifier RV. In the illustrated exemplary embodiment, the frequency band between two adjacent optical WDM signals os1 to osM is approximately 100 GHz.

M optical pump signals ps1 to psM are formed in the M pump sources P₁ to P_{M} for amplification of the overall optical transmission signal os and of the first to M-th optical WDM signals os1 to osM contained in it, and these optical pump signals ps1 to psM are at the necessary first to M-th wavelengths λ_{P1} to λ_{PM} for amplification of the optical WDM signals os1 to osM using the Raman effect. The first to M-th wavelengths λ_{P1} to λ_{PM} of the optical pump signals ps1 to psM are stabilized, in the exemplary embodiment under consideration, via the first to M-th filter units FG₁ to FG_{M}.

The optical pump signals ps1 to psM are combined via the second optical multiplexer MUX2 to form an overall optical pump signal PS, and are coupled in opposite directions into the optical fiber OF via the optical coupling unit EV. For this purpose, the second optical multiplexer MUX2 is in the form of a wavelength division multiplexer, and is intended for combination of the first to M-th optical pump signals ps1 to psM before they are coupled into the optical fiber OF.

The optical pump signals ps1 to psM are used in the optical fiber OF to supply energy to the optical WDM signals os1 to osM by utilizing the Raman effect. This leads to amplification of the overall optical transmission signal os and of the first to M-th optical WDM signals os1 to osM. In the exemplary embodiment under consideration, the Raman amplifier RV is operated in its linear operating mode; that is to say, the Raman amplifier RV has an approximately flat gain spectrum, so that all the optical WDM signals os1 to osM are subjected to approximately the same amplification. In addition, the power levels of the pump sources P₁ to P_{M} can be adjusted separately in order to produce an individual gain spectrum or for different amplification of the first to M-th optical WDM signals os1 to osM.

When the optical transmission system OTS together with the active Raman amplifier RV is first brought into use, the measurement unit ME is used to determine the power distribution of the optical WDM signals os1 to osM along the optical fiber OF. To do this, the measurement unit ME is, for example, in the form of an optical time domain reflectometer (OTDR), in which a high-power, pulsed optical test signal is coupled into the optical fiber OF via the optical coupling unit OK, and those signal components of the test signal which are backscattered as a result of the Rayleigh effect are evaluated. The evaluated backscattered signal components are used to determine the power distribution of the individual optical WDM signals os1 to osM along the optical fiber OF. Alternatively, a computer-aided simulation of the optical transmission system OTS can be carried out on the basis of the available system data, via which the power level distribution of the optical WDM signals os1 to osM along the optical transmission path OF likewise can be determined.

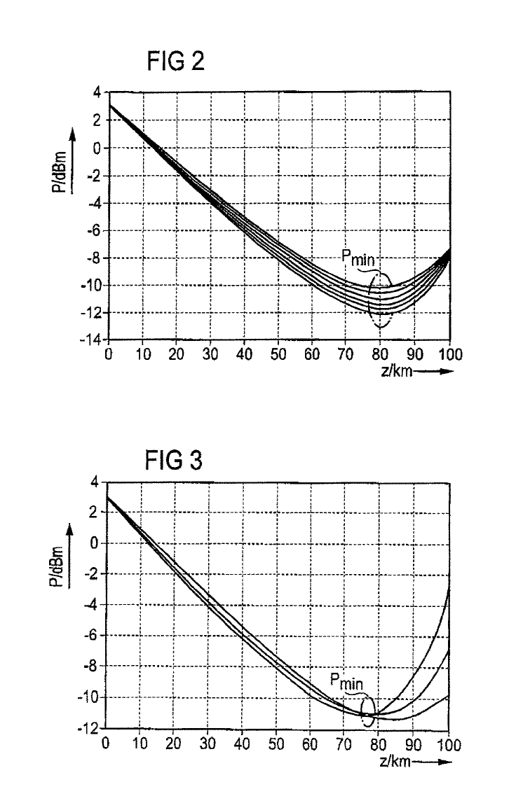

By way of example, FIG. 2 shows one possible profile of the power levels of the optical WDM signals os1 to osM along the optical transmission fiber OF in the form of a graph. The illustrated power level profiles clearly show that the minimum power levels Pₘᵢₙ of the optical WDM signals os1 to osM are widely different for a transmission path length of approximately 80 km. Such a different distribution of the power levels of the optical WDM signals os1 to osM is obtained for optical WDM signals os1 to osM with approximately the same input power levels at the input I of the optical fiber OF; that is to say, approximately identical power levels at the input I of the optical transmission system OTS result in different minimum power levels Pₘᵢₙ of the optical WDM signals OS1-OSM at the same point in the optical transmission path. The different WDM signals os1 to osM thus have different noise ratios, causing different signal-to-noise ratios at the output I of the optical transmission path.

In order to improve the signal-to-noise ratio of the optical transmission system OTS according to the present invention, actuating signals ss1 to ss7M are first of all formed in the control unit SE on the basis of the power level distribution (as determined using the measurement unit ME) of the optical WDM signals os1 to osM along the optical fiber OF, and these actuating signals ss1 to ss7M are used to adjust the input power levels or power levels of the optical WDM signals os1 to osM at the input I of the optical fiber OF. To this end, the first to M-th actuating signals ss1 to ssM are transmitted via the actuating line SL to the adjustable first to M-th transmitting units SE1 to SEM, in which the transmission power or the power level of the optical WDM signals os1 to osM is set on the basis of the respectively received first to M-th actuating signals ss1 to ssM. According to the present invention, the power levels of the optical WDM signals os1 to osM at the start I of the optical fiber OF are set, for example, in the optical transmitting units SE1 to SEM such that the optical WDM signals os1 to osM in the optical fiber OF have at least approximately the same minimum power levels Pₘᵢₙ.

FIG. 3 shows the distribution of the power levels of the optical WDM signals os1 to osM, after the matching or adjustment process according to the present invention, in a further graph. The illustrated power level profiles show that the minimum power levels Pₘᵢₙ of virtually all the optical WDM signals os1 to osM are raised from the least or lowest power level value −12 dBm to the greatest minimum power level value −11 dBm, so that the minimum power levels Pₘᵢₙ of the optical WDM signals os1 to osM are approximately the same. In the illustrated exemplary embodiment, the input levels or power levels of the optical WDM signals os1 to osM in the first to M-th optical transmitting units SE1 to SEM are raised to such an extent that the power levels of the optical WDM signals os1 to osM, whose minimum power levels were below the greatest minimum power level of all the optical WDM signals OS1 to OSM, now also have the higher minimum power level. The difference levels between the greatest minimum power level and the smaller further minimum power levels are, according to the present invention, evaluated as a manipulated variable, by which the power levels of the optical WDM signals os1 to osM, which have excessively low minimum power levels, are raised at the start I of the optical transmission path.

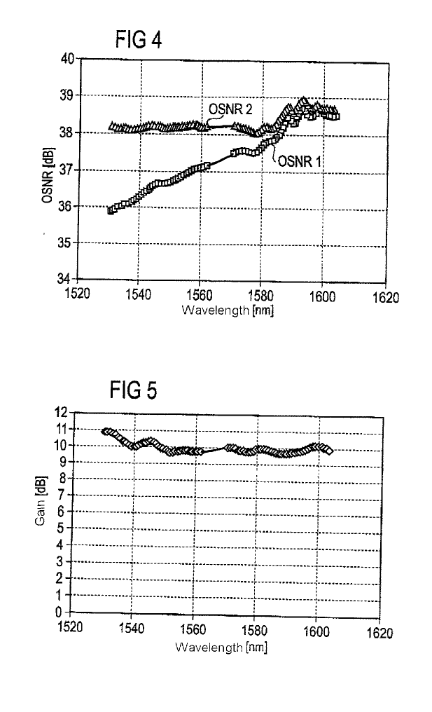

For the exemplary embodiment under consideration, FIG. 4 shows the improvement to the optical signal-to-noise ratio of the optical transmission system OTS as a result of the adjustment or matching of the input power levels of the optical WDM signals os1 to osM, according to the present invention, on the basis of a first and second signal-to-noise ratio profile OSNR1, OSNR2, plotted against the wavelength at the output of the optical transmission system OTS. In this case, the first signal-to-noise ratio profile OSNR1 shows the profile of the signal-to-noise ratio for identical power levels of the optical WDM signals os1 to osM at the start of the optical transmission system OTS, and the second signal-to-noise ratio profile OSNR2 shows the profile of the signal-to-noise ratios once the power levels of the optical WDM signals os1 to osM have been adjusted or matched according to the present invention.

A considerable improvement can be seen in the signal-to-noise ratio, in particular for those optical WDM signals OS1 to OSM which are at shorter wavelengths. Thus, as shown in FIG. 4, the signal-to-noise ratio of the optical transmission system OTS has been considerably improved by the matching, according to the present invention, of the power levels of the optical WDM signals os1 to osM, such that the signal-to-noise ratio profile has become considerably flatter. When the signal-to-noise ratio has a profile such as this when plotted against the wavelength, this also indicates a considerable increase in the pump power efficiency of the Raman amplifier RV.

By way of example, FIG. 5 shows the profile of the gain spectrum of the Raman amplifier RV. The distribution of the power between the individual pump signals ps1 to psM is, in this case, chosen such that all the optical WDM signals os1 to osM are subjected to approximately the same gain, or are amplified to approximately the same extent. This is particularly clear from the gain spectrum profile illustrated in FIG. 5, which has an approximately flat profile. By way of example, in the illustrated exemplary embodiment, M=7 optical pump signals ps1 to ps7 were produced at the following mean wavelengths λ1 to λ7: 1423 nm, 1436 nm, 1453 nm, 1467 nm, 1482 nm, 1496 nm and 1510 nm. These 7 optical pump signals ps1 to ps7 were coupled into the optical fiber OF at pump signal power levels of 24.5 dBm, 23.4 dBm, 20.0 dBm, 19.0 dBm, 18.0 dBm, 17.0 dBm and 18.2 dBm. The deliberately chosen non-uniform distribution of the pump signal power levels results in the Raman amplifier RV gain spectrum as shown in FIG. 5, with an approximately flat profile. In order to achieve such a flat gain spectrum, the power distribution of the optical pump signals ps1 to psM must be individually matched to the system characteristics of the optical transmission system OTS.

Although the present invention has been described with reference to specific embodiments, those of skill in the art will recognize that changes may be made thereto without departing from the spirit and scope of the present invention as set forth in the hereafter appended claims.

The invention is claimed as follows:

1. An optical transmission system with an improved signal-to-noise ratio for optical wavelength division multiplexed signals, comprising at least one optical fiber wherein power levels of the optical wavelength division multiplexed signals at a start of the optical fiber are set such that the optical wavelength division multiplexed signals in the optical fiber have at least approximately the same minimum power levels.

2. An optical transmission system as claimed in claim 1, further comprising a measurement unit for measuring the minimum power levels of the optical wavelength division multiplexed signals.

3. An optical transmission system as claimed in claim 2, further comprising a control unit for evaluating the measured minimum power levels and thereafter forming actuating signals via which the power levels of the optical wavelength division multiplexed signals are set once at the start of the optical fiber.

4. An optical transmission system as claimed in claim 1, further comprising at least one adjustable optical transmitting device for setting the power levels of the optical wavelength division multiplexed signals at the start of the optical fiber.

5. An optical transmission system as claimed in claim 3, wherein the control unit determines both a greatest minimum power level of the optical wavelength division multiplexed signals and difference levels between the greatest minimum power levels and the further minimum power levels, with the actuating signals being used to match the input power levels of the optical wavelength division multiplexed signals at the start of the optical fiber to reduce the determined difference levels.

6. An optical transmission system as claimed in claim 1, further comprising at least one Raman amplifier with a plurality of optical pump sources for amplification of the optical wavelength division multiplexed signals, wherein pump signal power levels of the Raman amplifier are chosen such that the power levels of the optical wavelength division multiplexed signals are amplified at least approximately to the same extent.

7. An optical transmission system as claimed in claim 6, wherein an operating mode of the Raman amplifier is linear.

8. An optical transmission system as claimed in claim 6, further comprising an input coupling device for input coupling of optical pump signals produced in the optical pump sources, wherein the optical pump signals are coupled into the optical fiber in a direction opposite to a transmission direction of the optical wavelength division multiplexed signals.

9. An optical transmission system as claimed in claim 6, further comprising a wavelength division multiplexer for combining the optical wavelength division multiplexed signals before being coupled into the optical fiber.

10. An optical transmission system as claimed in claim 6, wherein the pump signal power levels of the optical pump sources for amplification of the optical wavelength division multiplexed signals are separately adjustable.
